(19) United States
(12) Patent Application Publication
(10) Pub. No.: US 2015/0154583 A1
(43) Pub. Date: Jun. 4, 2015

(54) SYSTEMS AND METHODS FOR ALLOWING ACCESS TO CONTENT THROUGH MICROPAYMENTS

(71) Applicants: BYRON DANIEL BERNSTEIN, Encino, CA (US); ALEXANDER PAUL RINGE, Ladera Ranch, CA (US); ELLIOTT KYLE VENCZEL, Chestermere (CA)

(72) Inventors: BYRON DANIEL BERNSTEIN, Encino, CA (US); ALEXANDER PAUL RINGE, Ladera Ranch, CA (US); ELLIOTT KYLE VENCZEL, Chestermere (CA)

(21) Appl. No.: 14/093,870

(22) Filed: Dec. 2, 2013

(51) Int. Cl. G06Q 20/22

(52) U.S. Cl. CPC G06Q 20/29

(57) ABSTRACT

Systems and methods for allowing access to content through micropayments are disclosed. The systems and methods include a medium, which may be installed on a user's computer or otherwise accessed by a user. When the user wishes to access content provided by a content provider that has registered with the medium, the user may be prompted to approved a micropayment before accessing the content. The micropayment approval may cause a small amount of money, such as, e.g., $0.01, to be transferred from the user's account to the provider's account within the medium. Since the transaction is handled entirely within the medium, it avoids transaction fees that normally make micropayments too costly. Users may only add funds from, and providers may only withdraw funds to, external accounts in amounts that make such transactions cost-effective.

### BACKGROUND

The embodiments herein relate generally to systems and methods for allowing access to content through automated micropayments, for example, between a website user and a website owner or operator.

Advertising, present on many websites, is not effective for monetizing website content. For example, a website user spends 30 seconds watching a video advertisement for the website to earn $0.01. If the user values his or her time at more than $1.20 an hour, it is not worth the user's time to watch a 30 second advertisement for the website to earn one cent. Users often use software, such as AdBlock or the like, to avoid the advertisement or leave the website before viewing the content. There is no option for the user to simply pay $0.01 to skip the advertisement, since there is no existing method to automatically transfer $0.01 from the user to the website.

Currently, websites can monetize their content through registration and subscriptions. Not all users, however, are willing to register or subscribe. With a system in place to quickly, or even automatically, pay $0.01 to skip an advertisement or access content, more users may be willing to pay for content, thus boosting websites' revenue.

### SUMMARY

According to one embodiment of the present invention, a computerized method cost-effectively completes a micropayment transaction that allows a user to access content from a content provider. The method includes creating and storing a provider account associated with a content provider. The provider account includes an account balance. The method includes creating and storing a user account associated with a user. The user account includes an account balance. The content provider requires a micropayment from the user to access the content. The method includes receiving a micropayment authorization from a remote medium for the user to access content provided by the content provider. The method includes transferring an amount of the micropayment from the user account's account balance to the provider account's account balance. The method includes transmitting a content authorization to the remote medium. The content authorization is configured to instruct the medium and/or content provider to allow displaying the content to the user.

Optionally, the method may include checking that the account balance of the user account contains sufficient funds to allow the micropayment to be deducted while maintaining a non-negative account balance. The method may include transferring funds to the user account's account balance from an external account. The amount of the funds transferred may include a value high enough to make the transaction cost-effective. The method may include transferring funds from the provider's account balance to an external account. The amount of the funds transferred may include a value high enough to make the transaction cost-effective.

### BRIEF DESCRIPTION OF THE FIGURES

The detailed description of some embodiments of the present invention is made below with reference to the accompanying figures, wherein like numerals represent corresponding parts of the figures.

FIG. 1 shows a schematic of systems participating in a method for allowing access to content through micropayments, according to an embodiment of the present invention.

FIGS. 2 and 3 show a flowchart view of a method for allowing access to content through micropayments, according to an embodiment of the present invention.

### DETAILED DESCRIPTION OF CERTAIN EMBODIMENTS

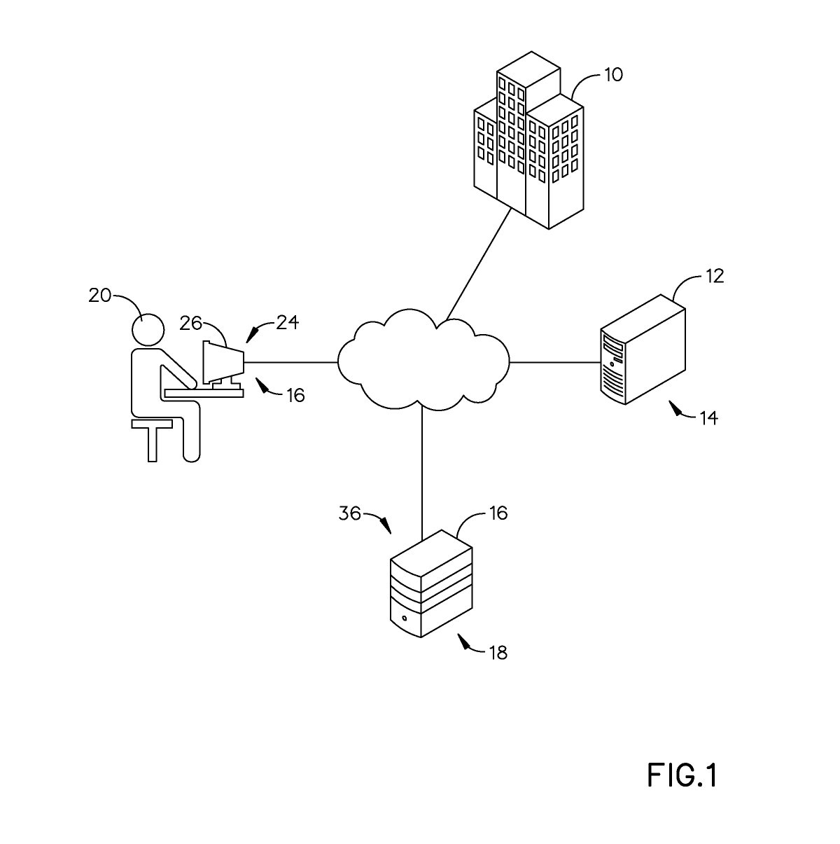

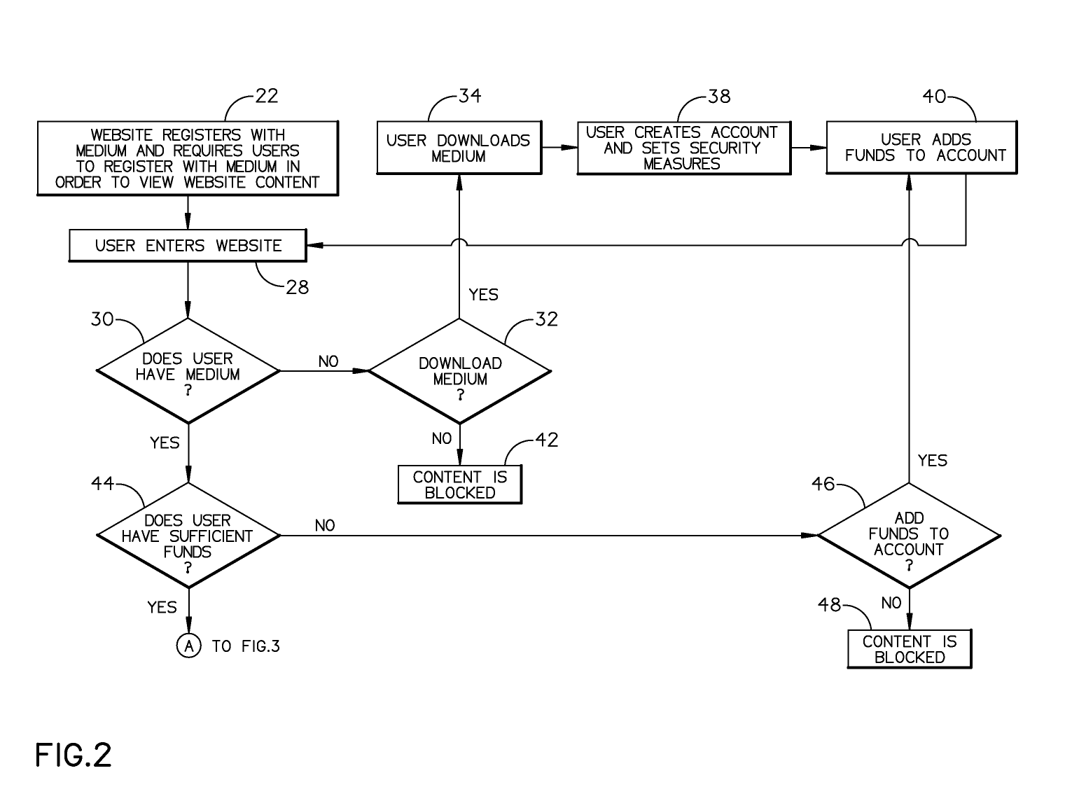

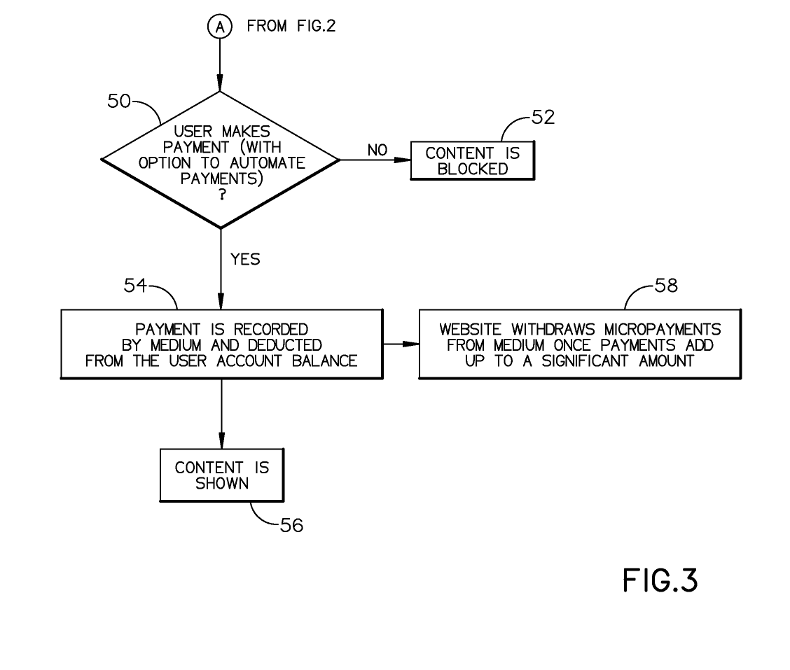

By way of example, and referring to FIGS. 1-3, one embodiment of the present invention comprises a method for allowing access to content through micropayments. As used herein, “medium” refers to technology that is used to complete a micropayment transaction that allows a user to access content from a content provider. The medium may include, for example, one or more of a plugin for a web browser, an application programming interface (API), a back-end server, and so on. The following description refers to a “website,” a “web browser,” and so on. Those skilled in the art will appreciate that embodiments of the present invention may be used with content systems other than a website and with content viewers other than a web browser, without departing from the spirit and scope of the present invention.

A content provider 10 may own and/or operate a website 12 for providing content 14. The content provider 10 may register the website 12 with the medium 16, creating a provider account 18. The provider account 18 may include an account balance. The provider 10 may configure the website 12 to require a user 20 to register with the medium 16 to view the content 14 (box 22). When a user 20 desires to view the content 14, the user may launch a web browser 24 on his personal computer 26, and the web browser 24 may interact with the website 12 (box 28). The web browser 24 may run on another computing platform, such as a laptop, tablet, smartphone, mobile device, set-top box, or the like.

The website 12 may query the browser 24 to determine is the browser 24 has the medium 16 installed, has access to the medium 16, or can otherwise execute the medium 16, depending on the specific embodiment in use (box 30). If not, the user 20 may be prompted to download and install the medium 16 (box 32). Once download is complete (box 34), the user 20 may create a user account 36 on the medium (box 38) and add funds to the user account 36 (box 40). For other embodiments, the user 20 may simply need to create a user account 36 (box 38) and add funds to the account 36 (box 40) without downloading or installing. If the user 20 elects to not download or install the medium 16, the content 14 may be blocked (box 42). The user 20 may be able to set certain security options in his user account 36. For example, the user may set a minimum cost that requires user approval, change when notifications of payment appear, and set amount of time to stay signed-in with the medium 16 (box 38).

Once the website 12 has determined that the user 20 has the medium 16, the website 12 may query the medium 16 to determine if the user 20 has sufficient funds in his account 36 to access the content 14 (box 44). If not, the user 20 may be prompted to add funds (box 46). The user may add funds from an external account, such as, e.g., a bank account, a checking account, a credit card, a debit card, or the like. If the user 20 decides not to add funds, the content 14 may be blocked (box 48).

The website 12 and/or the medium 16 may prompt the user 20 to make a payment to access the content 14 (box 50). The prompt may include an option to automate future payments for the website 12. If the user 20 declines the payment, the content may be blocked (box 52). If the user 20 agrees to the payment (or if the user has previously authorized automatic payments for the website 12), the amount of the payment may be deducted from the account balance in the user account 36 and added to the account balance in the provider account 18 (box 54). The content 14 may be shown to the user 20 once the micropayment transaction is completed (box 56).

The amount of the payment may be relatively small, such as, e.g., $0.05, $0.01, or less. Small payments, such as these, may be known as micropayments. Micropayments are typically not cost-effective, because payment providers, such as, e.g., credit card networks like Visa® and MasterCard®, and other processors like PayPal®, charge transaction fees for each transaction. The transaction fee may include a flat fee base rate plus a percentage of the transaction amount. If the transaction fee exceeds the profit margin on the transaction, then the payment may not be cost-effective. In the case of micropayments, the transaction fee may exceed the total value of the transaction itself. Embodiments of the present invention may avoid the problem of micropayment transaction fees by only allowing money to be added to or withdrawn from an account in cost-effective amounts, while keeping the actual micropayments within the medium 16. For example, the user 20 may be required to specify an amount above a minimum to add funds to his account. The minimum may be, e.g., $1.00, $5.00, $10.00, or any other amount that makes the transaction cost-effective. Similarly, the content provider 10 may be required to specify an amount above a minimum when withdrawing funds from its account 18 (box 58). If the account balance is not above the minimum, the provider 10 may not be able to make a withdrawal. The minimum may be, e.g., $1.00, $5.00, $10.00, or any other amount that makes the transaction cost-effective. The medium 16 may, for example, collect a service fee when a provider 10 makes a withdrawal. The content provider 10 may transfer funds from the provider account 18 to an external account, such as a bank account or the like.

If the user 20 makes a choice, at any point, that results in blocked content, the provider 10 may opt instead to display one or more advertisements to the user 20. The advertisements may be displayed prior to displaying the content 14, or the advertisements may be displayed alongside the content 14.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A computerized method for cost-effectively completing a micropayment transaction that allows a user to access content from a content provider, the method comprising:
creating and storing a provider account associated with a content provider, the provider account comprising an account balance;
creating and storing a user account associated with a user, the user account comprising an account balance;
receiving a micropayment authorization from a remote medium for the user to access content provided by the content provider, wherein the content provider requires a micropayment from the user to access the content;
transferring an amount of the micropayment from the user account's account balance to the provider account's account balance; and
transmitting a content authorization to the remote medium, the content authorization configured to instruct at least one of the medium and the content provider to allow displaying the content to the user.

2. The computerized method of claim 1, further comprising:
checking that the account balance of the user account contains sufficient funds to allow the micropayment to be deducted while maintaining a non-negative account balance.

3. The computerized method of claim 1, further comprising:
transferring funds to the user account's account balance from an external account, the amount of funds comprising a value high enough to make the transaction cost-effective.

4. The computerized method of claim 1, further comprising:
transferring funds from the provider's account balance to an external account, the amount of funds comprising a value high enough to make the transaction cost-effective.
